(19) United States
(12) Patent Application Publication
(10) Pub. No.: US 2018/0150290 A1
(43) Pub. Date: May 31, 2018

(54) SOFTWARE UPDATE DEVICE, SOFTWARE UPDATE SYSTEM, AND SOFTWARE UPDATE METHOD

(71) Applicant: KYOCERA CORPORATION, Kyoto (JP)

(72) Inventor: Munehito MATSUDA, Omihachiman-shi, Shiga (JP)

(21) Appl. No.: 15/576,218

(22) PCT Filed: May 26, 2016
(86) PCT No.: PCT/JP2016/065524

§ 371 Date: Nov. 21, 2017

(30) Foreign Application Priority Data
May 26, 2015 (JP) 2015-105959

(51) Int. Cl. G06F 8/65; B60R 16/023; G06F 11/14

(52) U.S. Cl. CPC G06F 8/65; G06F 8/66; G06F 11/1433; B60R 16/0231

(57) ABSTRACT

A communicator communicates with an external device. At least one processor receives update software for updating software of an electronic device and update condition information indicating an update condition for executing an update of the software from an external device via a communicator. At least one processor determines whether or not the update condition is satisfied.

### TECHNICAL FIELD

The present disclosure relates to a software update device, a software update system, and a software update method.

### BACKGROUND ART

An in-vehicle device is conventionally mounted on a vehicle. The in-vehicle device stores a program, executes the program, and thereby operates. The in-vehicle device can communicate with a center server disposed in a program provider, for example. The center server stores update information of the program of the in-vehicle device. The in-vehicle device requests the update information to the center server when an engine stopping is detected. Upon receiving the request, the center server transmits the update information to the in-vehicle device. Then, the in-vehicle device determines whether or not the update information includes an update file, and updates the program using the update file when the update information includes the update file.

### SUMMARY

### Problem to be Solved by the Invention

However, there is more room for an update condition to update software.

Thus, it is an object of the present disclosure to provide a software update device capable of updating software based on an update condition which can be dynamically changed.

### Means to Solve the Problem

A software update device, a software update system, and a method of updating software are disclosed. In one embodiment, a software update device is connected to an electronic device for executing software. The software update device comprises a communicator, a download unit, an update propriety determination unit, and a transmitter. The communicator communicates with an external device. The download unit receives update software for updating software of an electronic device and update condition information indicating an update condition for executing an update of the software from an external device via the external device. The update propriety determination unit determines whether or not the update condition is satisfied. The transmitter transmits a command to update the software using the update software to the electronic device when it is determined that the update condition is satisfied.

The software update system comprises an electronic device, an external device, and a software update device. The electronic device executes software. The external device stores an update software for updating software of the electronic device and update condition information indicating an update condition for executing an update of the software. The software update device comprises a communicator, a download unit, an update propriety determination unit, and a transmitter. The communicator communicates with an external device. The download unit receives the update software and the update condition information from the external device via the communicator. The update propriety determination unit determines whether or not the update condition is satisfied. The transmitter transmits a command to update the software using the update software to the electronic device when it is determined that the update condition is satisfied.

A method of updating software is a method of updating software for transmitting a command to update the software to an electronic device for executing the software. The method of updating software receives an update software for updating the software and update condition information indicating an update condition for executing an update of the software from an external device, determines whether or not the update condition is satisfied, and transmits a command to update the software using the update software to the electronic device when it is determined that the update condition is satisfied.

### Effects of the Invention

According to the present software update device, the present software update system, and the present software update method, the software can be updated based on the update condition which can be dynamically changed.

### BRIEF DESCRIPTION OF DRAWINGS

FIG. 1 A drawing schematically illustrating an example of a software update system.

FIG. 2 A flow chart illustrating an example of an operation of an update controller.

FIG. 3 A drawing schematically illustrating an example of the software update system and an external device.

FIG. 4 A flow chart illustrating an example of the operation of the update controller.

FIG. 5 A drawing schematically illustrating an example of an inner configuration of the update controller.

FIG. 6 A flow chart illustrating an example of the operation of the update controller.

FIG. 7 A flow chart illustrating an example of the operation of the update controller.

FIG. 8 A flow chart illustrating an example of the operation of the update controller.

FIG. 9 A flow chart illustrating an example of the operation of the update controller.

FIG. 10 A drawing schematically illustrating an example of an inner configuration of the update controller.

FIG. 11 A flow chart illustrating an example of the operation of the update controller.

### DESCRIPTION OF EMBODIMENT(S)

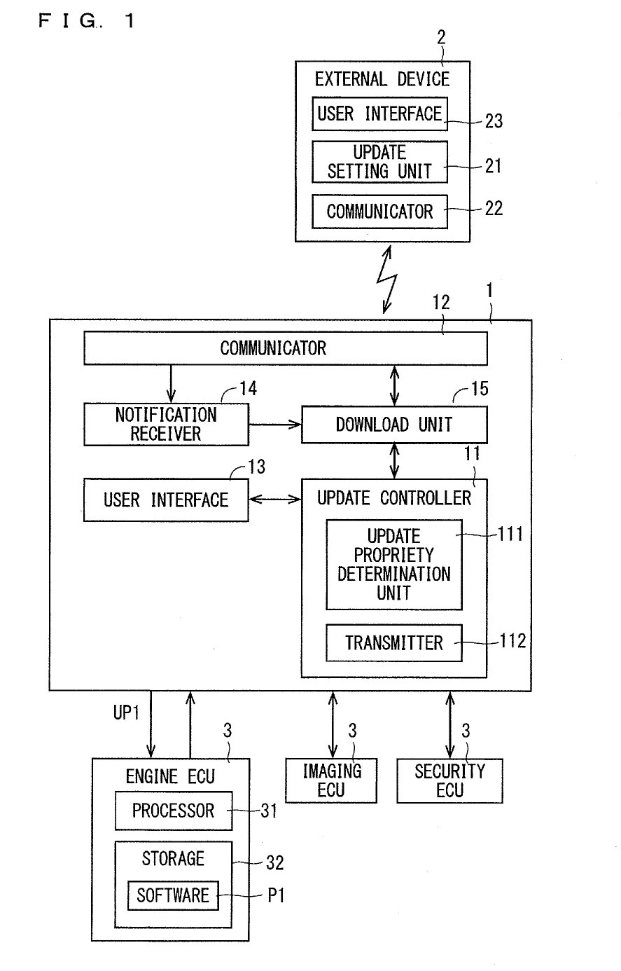

FIG. 1 is a drawing schematically illustrating an example of a configuration of a software update device 1. The software update device 1 is connected to an electronic device 3. The connection herein includes a wired connection and a wireless connection. As illustrated in FIG. 1, the software update device 1 may be connected to the plurality of electronic devices 3.

The electronic device 3 includes a processor 31 and a storage 32. FIG. 1 illustrates an inner configuration of only one of the electronic devices 3, however, other electronic devices 3 also include the processor 31 and the storage 32.

The storage 32 includes a storage medium such as a read only memory (ROM) and stores software P1 (including a program and a setting value, and also including firmware) for defining an operation of the electronic device 3. The processor 31 is a central processing unit (CPU) or a digital signal processor (DSP), for example, and reads out the software P1 from the storage 32 to execute the software P1, thereby the electronic device 3 operates.

The software update device 1 can transmit update software UP1 to each electronic device 3. The processor 31 in each electronic device 3 can receive the update software UP1 from the software update device 1, and update the software P1 stored in its storage 32 using the update software UP1. The processor 31 in each electronic device 3 therefore operates with the newest software P1. The operation of the processor 31 is described as the operation of the electronic device 3 hereinafter in some cases. For example, it is described that the electronic device 3 updates the software P1 in some cases.

The software update device 1 and the electronic device 3 described above may be provided in an optional system, and are provided in a vehicle, for example. In the above case, an electronic control unit (ECU) for controlling each configuration in the vehicle, for example, can be adopted as each of the plurality of electronic devices 3. For example, the ECU includes an engine ECU for controlling an engine, a brake ECU for controlling a brake, an audio ECU for controlling an audio, an image EPU for controlling an imaging unit (an image sensor), and a security ECU for controlling a security device. An alarm device for providing an alarm in accordance with an oscillation during an engine stopping or a locking device for locking a steering during the engine stopping, for example, can be adopted as the security device.

As illustrated in FIG. 1, the software update device 1 can communicate with an external device 2. The external device 2 is a server, for example, and is a device for distributing the update software UP1. The external device 2 includes an update setting unit 21, a communicator 22, and a user interface 23, for example. The communicator 22 is a communication circuit, and can wirelessly communicate with the software update device 1, for example. The user interface 23 includes a display and an input unit, for example. The display displays contents of notification to a user and an operation menu, for example. The input unit, which is operated by the user, inputs contents of the operation to the update setting unit 21, for example.

The update setting unit 21 can set the update software UP1 in accordance with an input performed by the user on the input unit. For example, the update setting unit 21 stores the update software UP1 in a storage (not shown) in the external device 2. The update setting unit 21 can further set update condition information in accordance with an input performed by the user on the input unit. The update condition information indicates a condition for executing the update software UP1. As described hereinafter, when the condition indicated in the update condition information is established, the software update device 1 causes the electronic device 3 to update the software P1 using the update software UP1. The storage in the external device 2 also stores the update condition information.

The update setting unit 21 may generate an update list which associates version information of the update software UP1 with the update condition information. The version information indicates which update the update software UP1 corresponds to in a case where the update is performed multiple times on a predetermined software P1. When the update list is transmitted to the software update device 1, the software update device 1 can recognize a version of the update software UP1 which is set, and the update condition of the update software UP1 based on the update list.

As illustrated in FIG. 1, the software update device 1 includes an update controller 11, a communicator 12, a command receiver 14, and a download unit 15. The communicator 12 is a communication circuit, and can wirelessly communicate with the external device 2, for example.

A section including the update controller 11, the command receiver 14, and the download unit 15 can control the update of the software P1 in the electronic device 3. The operation thereof is described in more detail hereinafter.

The command receiver 14 can receive an update notification from the external device 2 via the communicator 12. The update notification is transmitted when new update software is set in the external device 2, for example.

The download unit 15 can receive the update software UP1 and the update condition information corresponding to the update software UP1 from the external device 2 via the communicator 12. When the external device 2 transmits the update list described above, the download unit 15 can also receive the update list via the communicator 12.

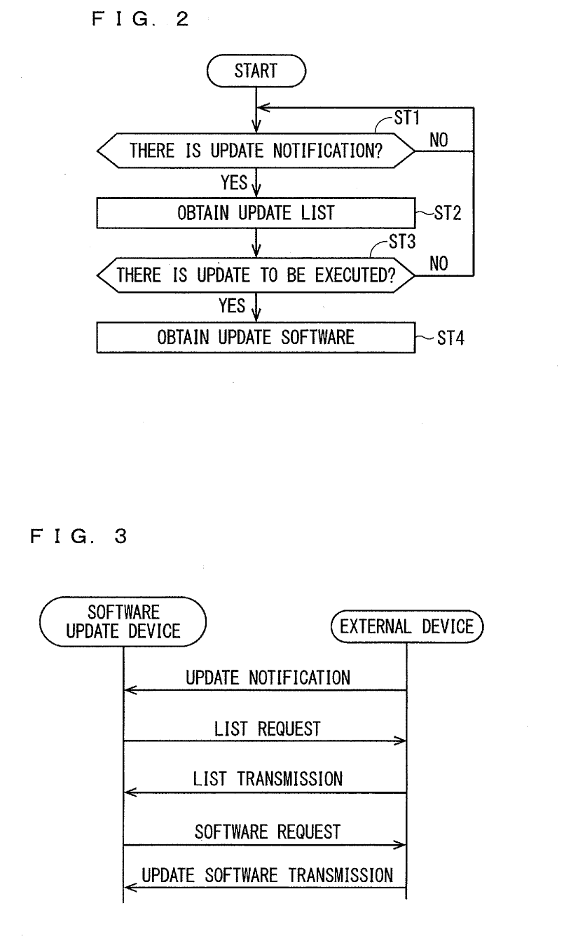

FIG. 2 is a flow chart illustrating an example of a specific operation of the update controller 11 at a time of receiving the update software UP1. In this example, the external device 2 transmits the update notification to the software update device 1. The update notification is transmitted when the update software UP1 is set in the external device 2 or at a predetermined time interval, for example. As illustrated in FIG. 2, the notification receiver 14 firstly determines whether or not the update notification is received from the external device 2 in Step ST1. When it is determined that the update notification is not received, the notification receiver 14 executes Step ST1 again.

When it is determined that the update notification is received, the download unit 15 requests the update list to the external device 2 via the communicator 12 to obtain the update list, for example, in Step ST2. As indicated by a table 1, the update list includes, for example, the version of the update software UP1 for each electronic device 3 and the update condition information for each update software UP1.

TABLE 1

| Electronic device | Version | Update condition |
|---|---|---|
| Engine ECU | 1.01 | Engine stopping |
| Imaging ECU | 1.05 | No backward travel |

The table 1 indicates an example of the update list in a case where the engine ECU and the imaging ECU are adopted as the electronic devices 3. The example in the table 1 indicates “1.01” as the version of the update software UP1 of the engine ECU. A state where the engine stops is adopted as the update condition. The reason is that when the engine operates, the software P1 of the engine ECU is in execution, so that the software P1 cannot be updated.

The example in the table 1 indicates “1.05” as the version of the update software UP1 of the imaging ECU. A state where the vehicle does not travel backward is adopted as the update condition. The reason is that the imaging unit is assumed to operate when the vehicle travels backward herein. That is to say, since the software P1 of the imaging ECU is executed when the vehicle travels backward, the software P1 is not updated when the software P1 of the imaging ECU is in execution.

Described herein is an example of an operation of the imaging ECU in the case where the vehicle travels backward. For example, four imaging units in total are mounted on both sides of forward and rear parts of the vehicle, respectively. The imaging ECU controls the four imaging units when the vehicle travels backward, and appropriately converts and synthesizes an image taken with each imaging unit, thereby generating an image of the vehicle viewed from above in a vertical direction. Then, the image is displayed on the display in the vehicle. Accordingly, the user can easily confirm a position and posture of the vehicle by visually recognizing the display. As a result, the user can easily park the vehicle.

In Step ST3 following Step ST2, the update controller 11 determines, based on the update list, whether or not there is the update software UP1 to be executed.

For example, the version of the current software P1 stored in the electronic device 3 is compared with the version of the update software UP1, and when they are the same, the update is not necessary. That is to say, the update controller 11 does not determine that the update software should be executed in the above case.

When the determination information for determining the update condition is not input from the electronic device 3 to the update controller 11, for example, the update condition cannot be determined, thus the update is not necessary. For example, the information indicating a state of engine operating/stopping may not be input from the engine ECU to the update controller 11 in the case where the engine stopping falls under the update condition. In the above case, the update condition cannot be determined, thus the update software UP1 corresponding to the update condition is not executed. Thus, also in the above case, the update controller 11 does not determine that the update software should be executed.

Conversely, the update controller 11 determines that the update software should be executed in the following case, for example. That is to say, when the version of the update software UP1 is superior to the version of the current software P1 in the electronic device 3, and the determination information necessary to determine the update condition corresponding to the update software UP1 is input from the electronic device 3 to the update controller 11, for example, the update controller 11 determines that the update software UP1 is the update software to be executed.

When it is determined in Step ST3 that there is no update software UP1 to be executed, the notification receiver 14 executes Step ST1 again. When it is determined in Step ST3 that there is the update software UP1 to be executed, the download unit 15 requests the update software UP1 to the external device 2 to obtain the update software UP1 in Step ST4. Then, the download unit 15 outputs the update software UP1 and the update condition information to the update controller 11.

In the manner described above, the update controller 11 obtains the update software UP1 to be executed and the update condition information corresponding to the update software UP1.

FIG. 3 schematically illustrates an example of a communication between the software update device 1 and the external device 2 in the case where there is the update software UP1 to be executed. Firstly, the update notification is transmitted from the external device 2 to the software update device 1. Next, the software update device 1 transmits the list request to the external device 2. Upon receiving the request, the external device 2 transmits the update list. The software update device 1 confirms the update list and determines that there is the update software UP1 to be executed, thereby requesting the update software UP1. Upon receiving the request, the external device 2 transmits the update software UP1 to the software update device 1.

In the example in FIG. 2 and FIG. 3, it is determined firstly whether or not there is the update software UP1 to be executed. Then, the update software UP1 is obtained from the external device 2 when the positive determination is made. This is not the necessary requirement for the software update device 1, but enables a reduction in a communication volume. The reason is that a data amount in the update software UP1 is larger than that in the update list. That is to say, the update list having the small data amount is requested, and the necessary update software UP1 is determined, using the update list, to request the update software UP1, thus the communication of the unnecessary update software UP1 is avoided to reduce the communication volume.

Next, the operation of updating the software P1 is described. As illustrated in FIG. 1, the update controller 11 includes an update propriety determination unit 111 and a transmitter 112.

The update controller 11, the notification receiver 14, and the download unit 15 may include, for example, a processor (a CPU or a DSP, for example) not shown and a storage (a ROM, for example) not shown. The storage stores software executed by the processor. It is applicable that the processor executes the software to achieve functions of the update controller 11 (for example, the update propriety determination unit 111 and the transmitter 112), notification receiver 14, and download unit 15. However, the configuration is not limited thereto, but all or part of the above functions may be made up of hardware. In short, the processor needs to include the circuit for executing the above functions. Each of the update controller 11, the notification receiver 14, and the download unit 15 may include the processor, or at least one processor may execute the functions of the update controller 11, notification receiver 14, and download unit 15.

The update condition information of the update software UP1 to be executed is input to the update propriety determination unit 111, and various determination information necessary to determine the update condition is also input. The update propriety determination unit 111 can determine whether or not the update condition is satisfied based on the determination information.

For example, the information indicating a state of an engine can be adopted to the update software UP1 for the engine ECU as the determination information. For example, it is applicable that the vehicle includes a detector for detecting a state of an engine key and information of the state of the engine is input to the update propriety determination unit 111 as the determination information.

For example, the information indicating whether or not the vehicle travels backward can be adopted to the update software UP1 for the imaging ECU as the determination information. For example, it is applicable that the vehicle includes a detector for detecting a state of a gearshift to change gears and information of the state of the gearshift is input to the update propriety determination unit 111 as the determination information.

The transmitter 112 can transmit the update software UP1 to the corresponding electronic device 3. For example, when the update propriety determination unit 111 determines that the update condition is satisfied, the transmitter 112 can transmit the update software UP1 corresponding to the update condition to the electronic device 3. In the above case, the electronic device 3 immediately executes the received update software UP1.

Alternatively, it is also applicable that the transmitter 112 transmits the update software UP1 to the electronic device 3 regardless of the update condition and transmits a command to execute the update software UP1 to the electronic device 3 when the update condition is satisfied. In the above case, upon receiving the command to execute the update software UP1, the electronic device 3 executes the update of the software P1 using the update software UP1. An embodiment of transmitting the update software UP1 when the update condition is satisfied is described hereinafter as an example. In this embodiment, the electronic device 3 receiving the update software UP1 immediately performs the update, thus the update software UP1 also functions as an execution command supplied to the electronic device 3.

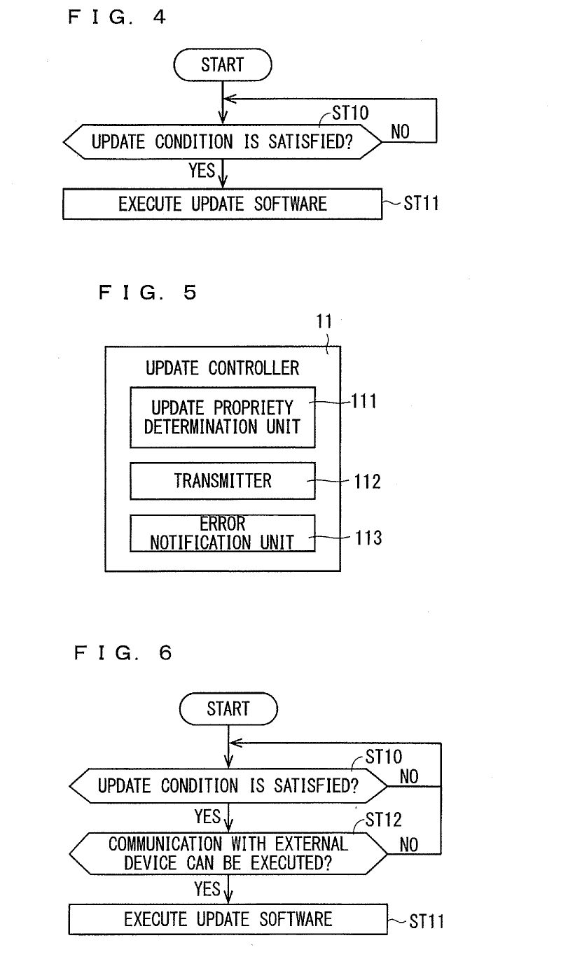

FIG. 4 is a flow chart illustrating an example of an operation of the update controller 11 at a time of executing the update software UP1. Firstly, in Step ST10, the update propriety determination unit 111 determines whether or not the update condition indicated in the update condition information is satisfied for each of the obtained update software UP1. The determination is performed on all of the pieces of the obtained update software UN. When it is determined that the update condition is not satisfied in any update software UP1, the update controller 11 executes Step ST10 again and waits for the next update notification.

When it is determined that the update condition corresponding to any update software UP1 is satisfied, the transmitter 112 transmits the update software UP1 corresponding to the update condition to the corresponding electronic device 3 in Step ST11. The electronic apparatus 3 (more particularly, the processor 31) updates the software P1 using the received update software UP1.

For example, information of the state of the engine key is input to the update propriety determination unit 111. Then, the update propriety determination unit 111 determines whether or not the engine stops as the determination of the update condition of the engine ECU. When it is determined that the engine stops, the transmitter 112 transmits the corresponding update software UP1 to the engine ECU. The engine ECU updates its software P1 using the received update software UP1.

For example, information of the state of the gearshift is input to the update propriety determination unit 111. Then, the update propriety determination unit 111 determines whether or not the gearshift is in a state of the backward travel as the determination of the update condition of the imaging ECU. When it is determined that the gearshift is not in the state of the backward travel, the transmitter 112 transmits the corresponding update software UP1 to the imaging ECU. The imaging ECU updates its software P1 using the received update software UP1.

As described above, the update software UP1 is executed when the update condition is satisfied. Thus, the update software UP1 corresponding to each electronic device 3 can be executed at an appropriate timing for each electronic device 3.

Moreover, the update condition information is set in the external device 2, and the update condition information is transmitted from the external device 2 to the software update device 1. Thus, when there are the plurality of software update devices 1, for example, a worker needs not visit each of the software update devices 1 to set the update condition, but only needs to set the update condition in the external device 2. That is to say, the update condition can be easily changed for substantially all of the software update devices 1 by setting the update condition in the external device 2.

There is a case where the update condition needs to be changed for a certain piece of software P1. In the example that the imaging ECU updates the software P1 when the vehicle does not travel backward as described above, for example, a function of taking a scenery while the vehicle is traveling is newly incorporated into the imaging ECU by updating the software P1 in some cases. When such a function is incorporated, the imaging ECU operates while the vehicle travels forward, thus it is not also preferable to update the software P1 of the imaging ECU while the vehicle travels forward.

Thus, the worker performs a resetting (change) of the update condition information for the imaging ECU in the external device 2 when setting the next update software UP1. For example, the engine stopping is set as the update condition. A table 2 indicates an example of the update list.

TABLE 2

| Electronic device | Version | Update condition |
|---|---|---|
| Engine ECU | 1.01 | Engine stopping |
| Imaging ECU | 1.05 | Other than backward travel |
| | 2.00 | Engine stopping |

The table 2 indicates that there are the update software UP1 of version “1.05” and the update software UP1 of version “2.00” for the imaging ECU. Herein, it is indicated that the version is newer as the number gets larger. “Engine stopping” is adopted as the update condition of the update software UP1 of version “2.00” in the table 2. This is caused by the update software of version “1.05” adding the function of operating also during the forward travel to the imaging ECU.

Since the resetting of the update condition is performed as described above, the update software UP1 of the imaging ECU can be executed at an appropriate timing.

As described above, the update condition needs to be changed depending on the update software UP1, however, according to the present embodiment, the update condition information can be set in the external device 2. Thus, the update condition can be changed easily in the manner described above.

The table 1 and the table 2 show the engine ECU and the imaging ECU as the example for simplify the description, however, more electronic devices 3 may be actually included.

The type of the electronic device 3 mounted on each vehicle may be different for each vehicle. For example, a security device may be different for each vehicle. At this time, the software P1 of the security ECU is different from another one, and its update software UP1 is also different from another one. In such a case, the update list may include the information of all of the electronic devices 3 provided in each vehicle. That is to say, the update list may include the information of the electronic device 3 which is not mounted on a certain vehicle. In the above case, the update controller 11 needs to extract only the information of the electronic device 3 which is connected to the update controller 11 from the update list. Such an extraction can be performed based on identification information (also referred to as a device ID) of the electronic device 3.

As described above, when the update list includes the information of all types of the electronic devices 3, the update setting unit 21 in the external device 2 needs not generate the update list for each vehicle, thus the processing can be easily performed.

<Update Condition of Update Software>

When a defect (that is to say, an error) occurs in updating the software P1 using the update software UP1, there is a possibility that the software P1 cannot be executed. That is to say, the update may cause malfunction in the electronic device 3. For example, when the function of the engine ECU is disabled, the user cannot move the vehicle.

Thus considered is a notification of an occurrence of the defect in updating the software P1 using the update software UP1 to the external device 2. However, there is a range in which the communication can be established in the wireless communication. Accordingly, when the software update device 1 is located outside the range, the software update device 1 cannot communicate with the external device 2 in some cases. In such a case, when the defect occurs in updating the software P1, the external device 2 cannot be immediately notified of the occurrence of the defect. Particularly, when a malfunction occurs in a movement function of a moving body (the vehicle herein), the moving body cannot be moved into the range in which the software update device 1 can communicate with the external device 2. Thus, the user needs to make contact with the external device 2 (more specifically, the worker) by the other means, so that time and effect are required. The reason is that the user does not often remember contact information of the worker, and thus needs to find out the contact information.

Thus, intended is the execution of the software P1 in the state where the software update device 1 can communicate with the external device 2. FIG. 5 is drawing schematically illustrating an example of an inner configuration of the update controller 11. As illustrated in FIG. 5, the update controller 11 further includes an error notification unit 113.

The update propriety determination unit 111 not only determines the update condition indicated in the update condition information but also determines whether or not the software update device 1 can communicate with the external device 2. When the update condition indicated in the update condition information is satisfied and the communication between the software update device 1 and the external device 2 can be established, the transmitter 112 transmits the update software to the corresponding electronic device 3. That is to say, when the update condition is satisfied and the communication between the software update device 1 and the external device 2 can be established, the transmitter 112 transmits the command to perform the update to the electronic device 3.

Accordingly, even when the defect occurs in updating the software P1, the software update device 1 can wirelessly communicate with the external device 2 at this time. When the defect occurs in updating the software P1, the electronic device 3 transmits the occurrence of the defect to the update controller 11. Upon receiving the transmission, the error notification unit 113 transmits the notification of the occurrence of the defect in updating the software P1 of the electronic device 3 to the external device 2 via the communicator 12. The notification described above is also referred to as the error notification hereinafter.

Upon receiving the error notification, the external device 2 transmits the notification to the worker using the user interface 23. Accordingly, the worker can recognize that the defect has occurred in updating the software P1.

When the external device 2 stores the contact information of the user, for example, the worker can make contact with the user. Accordingly, the worker can rush to the vehicle to easily recover the software P1.

FIG. 6 is a flow chart illustrating an example of a specific operation of the update controller 11. Step ST 12 is further executed compared with FIG. 4. Step ST12 is executed prior to Step ST11, and FIG. 6 shows that Step ST12 is executed between Step ST10 and Step ST11.

In Step ST12, the update controller 11 determines whether or not the communicator 12 can communicate with the external device 2. For example, it is applicable that signals are transmitted to the external device 2, and it is determined that the communicator 12 can communicate with the external device 2 when a response to the signals is appropriately received.

When the positive determinations are made in both Steps ST10 and ST12, the update of the software P1 is performed using the update software UP1 in Step ST11.

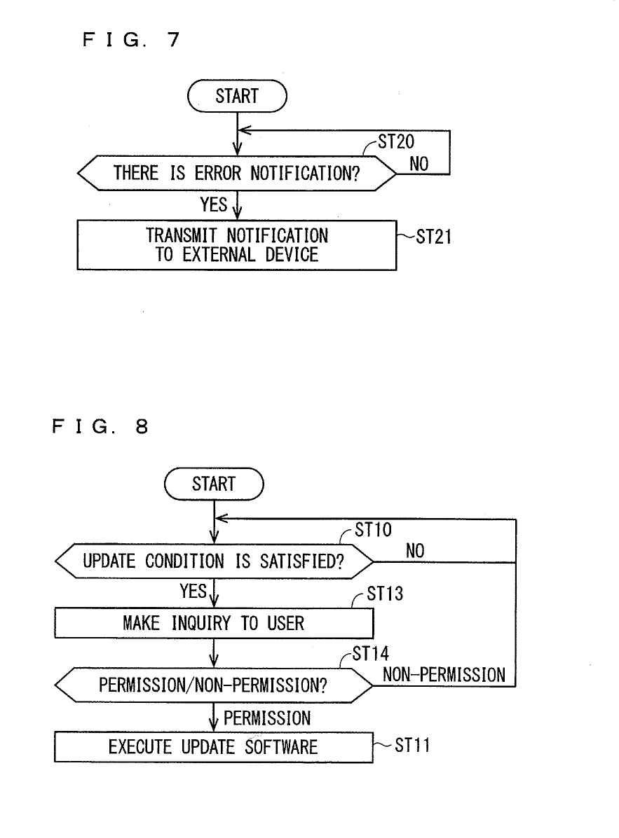

FIG. 7 is a flow chart illustrating an example of a specific operation of the error notification unit 113. The error notification unit 113 determines whether or not the error notification unit 113 has received the error notification from the electronic device 3 in Step ST20. When the error notification unit 113 has not received the error notification, the error notification unit 113 executes Step ST20 again. When the error notification unit 113 has received the error notification from the electronic device 3, the error notification unit 113 transmits the error notification to the external device 2 via the communicator 12 in Step ST21.

Since the description is made using the movable vehicle herein, described is the case where the software update device 1 cannot communicate with the external device 2 by reason that the software update device 1 is located outside the communication range. However, there is also a case where the external device 2 and the software update device 1 cannot communicate with each other due to a communication failure, for example. Even in such a case, the update of the software P1 may be performed after the communication is recovered, that is to say, after the software update device 1 can communicate with the external device 2.

<Necessity of Error Notification>

It is not necessary to apply the configuration of updating the software P1 in the state where the software update device 1 can communicate with the external device 2 as described above to all of the electronic devices 3. For example, it is applicable to update the software P1 of the electronic device 3 which does not contribute to the traveling of the vehicle in a state where the software update device 1 cannot communicate with the external device 2. The reason is that even when the malfunction occurs in the electronic device 3 which does not contribute to the traveling of the vehicle, urgency of recovering it is considered to be low. Conversely, it is preferable to update the software P1 of the electronic device 3 which relates to the traveling of the vehicle in a state where the software update device 1 and the external device 2 can communicate with each other. The reason is that, according to the above configuration, the notification is automatically transmitted to the worker when the malfunction occurs in the traveling of the vehicle as described above.

<Inquiry to User>

There is a case where even when the update condition is satisfied at a point in time, for example, the update condition becomes unsatisfied immediately afterwards due to the operation of the vehicle performed by the user. For example, when the user starts the engine in the case where the engine stopping is the update condition, the update condition becomes unsatisfied. In the above case, the update of the software P1 needs to be interrupted, or the operation of the vehicle performed by the user needs to be disabled.

The software P1 may be updated after obtaining a permission from the user so as to avoid such a matter. That is to say, the matter described above is avoided by notifying the user that the software P1 is updated and executing the software P1 after obtaining the permission from the user. In the illustration in FIG. 1, the software update device 1 includes a user interface 13. The user interface 13 includes an announcement unit such as a display or an audio output unit and an input unit, for example.

For example, the update propriety determination unit 111 may make an inquiry as to the propriety of updating the software P1, using the user interface 13, to the user when it is determined that the update condition is satisfied. This inquiry is made by a display or an audio, for example. In making the inquiry, the user may be notified of the electronic device 3 to be updated and a time required for the update. The time required to the update may be set by the worker, for example.

When the user permits the update of the software P1, the user inputs the permission via the user interface 13. Upon receiving the permission information from the user interface 13, the update propriety determination unit 111 determines that the software P1 can be updated. That is to say, the transmitter 112 transmits a command to update the software P1 to the corresponding electronic device 3 when the update propriety determination unit 111 determines that the update condition indicated in the update condition information is satisfied and the permission is obtained from the user.

According to the above configuration, the software P1 is not updated without the permission from the user, thus the update can be performed in a state where the software P1 may be updated more reliably.

FIG. 8 is a flow chart illustrating an example of an operation of the update controller 11. In the illustration in FIG. 8, Steps ST13 and ST14 are further executed compared with FIG. 4. Step ST13 is executed when the positive determination is made in Step ST10. In Step ST13, the update controller 11 makes the inquiry, using the user interface 13, as to the propriety of updating the software P1 using the update software UP1 to the user. Next, in Step ST14, the update controller 11 determines which is input, permission or non-permission, from the user.

When it is determined that the user has input the non-permission, the update controller 11 executes Step ST10 again. When the user has input the permission, the electronic device 3 executes the update of the software P1 using the update software UP1 in Step ST11.

<Importance Degree of Update Software>

An importance degree may be set in the update software UP1. For example, it is applicable to set the importance degree low for a minor update, and set the importance degree high for a major update. A method of setting the importance degree is certainly optional. The importance degree may be appropriately set in the update setting unit 21 in the external device 2. That is to say, the worker may set the importance degree of the update software UP1 together with setting the update software UP1.

The update controller 11 receives from the external device 2 information of the importance degree (the importance degree information) as well as the update software UP1. For example, the update list may include the importance degree information. A table 3 indicates an example of the update list including the importance degree information.

TABLE 3

| Electronic device | Version | Update condition | Importance degree |
|---|---|---|---|
| Engine ECU | 1.01 | Engine stopping | Large |
| Imaging ECU | 1.05 | No backward travel | Small |

In the illustration in the table 3, the importance degree of the update software UP1 of the engine ECU is large, and the importance degree of the update software UP1 of the imaging ECU is small. The importance degree does not need to be indicated by two values of “large” and “small”, for example, but may also be indicated by multiple values.

The update propriety determination unit 111 also determines whether or not the importance degree is higher than a predetermined reference value for each update software UP1. Then, with regard to the update software UP1 having the importance degree higher than the reference value, the update propriety determination unit 111 determines that the software P1 can be updated without the permission from the user when the update condition is satisfied. In contrast, with regard to the update software UP1 having the importance degree lower than the reference value, the update propriety determination unit 111 determines that the software P1 can be updated when the update condition is satisfied and the user permits the update. Accordingly, the software P1 having the high importance degree can be automatically updated.

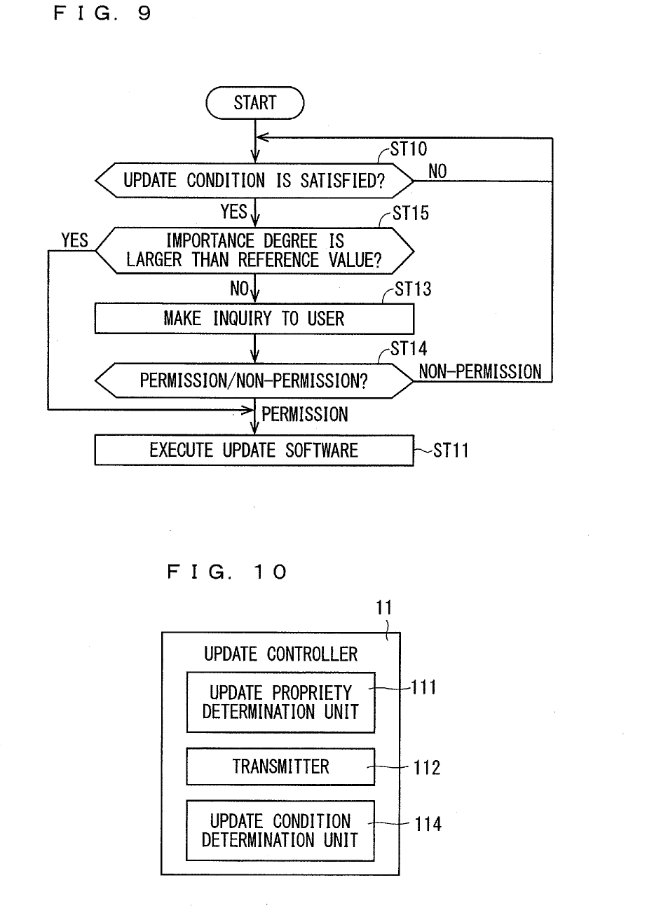

FIG. 9 is a flow chart illustrating an example of a specific operation of the update controller 11. In the illustration in FIG. 9, Step ST15 is further executed compared with FIG. 8. Step ST15 is executed between Step ST10 and Step ST13. In Step ST15, the update controller 11 determines whether or not the importance degree of the update software UP1 corresponding to the satisfied update condition is higher than the reference value. When the update controller 11 determines that the importance degree is higher than the reference value, the update controller 11 executes Step ST11 without executing Steps ST13 and ST14. That is to say, the software P1 is updated without making the inquiry to the user. In contrast, when the update controller 11 determines that the importance degree is lower than the reference value, the update controller 11 executes Steps ST13, ST14, and ST11.

<Necessity of Inquiry to User>

In the example described above, the necessity of the inquiry to the user is determined in accordance with the importance degree. The necessity information indicating the necessity of the inquiry may be transmitted from the external device 2 to the software update device 1. The update controller 11 makes the inquiry to the user based on the necessity information. The necessity information is set by the worker, for example. For example, the update list may include the necessity information corresponding to each update software UP1. A table 4 indicates an example of the update list including the necessity information.

TABLE 4

| Electronic | | | |
|---|---|---|---|
| device | Version | Update condition | Inquiry |
| Engine ECU | 1.01 | Engine stopping | Necessary |
| Imaging | 1.05 | No backward travel | Unnecessary |
| ECU | | | |

<Update Condition Set in Side of Electronic Device 3>

In the example described above, the update condition information is set for all of the pieces of the update software UP1, but is not limited thereto. The reason is that the update condition is set in a side of the electronic device 3 in some cases. For example, the update condition for the software P1 of the electronic device 3 is preset in the storage 32 in the electronic device 3.

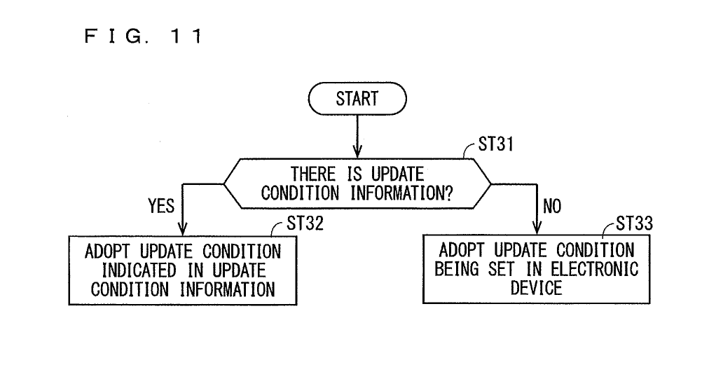

FIG. 10 is drawing schematically illustrating an example of an inner configuration of the update controller 11. As illustrated in FIG. 10, the update controller 11 further includes an update condition determination unit 114. The update condition determination unit 114 can also obtain the update condition being set in the electronic device 3. For example, the update condition determination unit 114 transmits a request signal for requesting the update condition to the electronic device 3, and the electronic device 3 returns the update condition being set in the electronic device 3 in accordance with the request signal. Then, when there is the update software UP1 in which the update condition information is not set in receiving the update list from the external device 2, the update condition determination unit 114 can adopt the update condition being set in the electronic device 3 as the update condition of the update software UP1.

According to the above configuration, when the update condition being set in the electronic device 3 is adopted, the update condition information does not need to be set in the external device 2. Thus, the time and effort of the worker can be reduced.

FIG. 11 is a drawing illustrating an example of a specific operation of the update controller 11 at the time of determining the update condition. In Step ST31, the update condition determination unit 114 determines, based on the update list, whether or not there is the update condition information corresponding to the update software UP1 to be executed. When the update condition determination unit 114 determines that there is the update condition information, the update condition determination unit 114 adopts the update condition indicated in the update condition information. When the update condition determination unit 114 determines that there is no update condition information, the update condition determination unit 114 adopts the update condition being set in the electronic device 3.

When neither the update condition information nor the update condition in the side of the electronic device 3 is set, the update controller 11 may execute the update software UP1 immediately after obtaining the update software UP1, for example.

<Example of Update Condition 1>

For example, the engine stopping near user's home (a parking space in user's home, for example) may be adopted as the update condition. The update condition can be applied to the update of the software P1 of the engine ECU, for example. That is to say, it can be considered that the user returns home in accordance with the state where the engine stops near the user's home, and it can be considered that the engine keeps stopping for relatively a long time afterwards. In the above case, the state appropriate for the update of the software P1 is maintained for relatively a long time.

A position of the vehicle is detected by a position acquisition sensor, for example. For example, the position acquisition sensor may acquire the position using global positioning system (GPS). In the GPS, the position acquisition sensor receives signals from a plurality of artificial satellites, and calculates the position based on the signals.

Home position information is input by the user, for example. In the illustration in FIG. 1, the software update device 1 includes the user interface 13, for example, and the user inputs the position of user's home (for example, an address) via the user interface 13.

The update propriety determination unit 111 determines whether or not the update condition is established based on the state of the engine, the position of the vehicle, and the home position information. For example, the update propriety determination unit 111 determines whether or not the vehicle is located near user's home when the engine is switched to stop. More specifically, the update propriety determination unit 111 determines whether or not a distance between the position of the vehicle and the position of user's home is smaller than a predetermined reference value at the above timing. Then, the update propriety determination unit 111 determines that the vehicle is located near user's home when the distance is smaller than the predetermined value.

Then, when it is determined that the update condition is satisfied, the update controller 11 transmits the update software UP1 to the corresponding electronic device 3 (the engine ECU). Upon receiving the update software UP1, the electronic device 3 (the engine ECU) updates its software P1 using the update software UP1.

<Example of Update Condition 2>

For example, the engine stopping near a recovery place (a dealer or a repair store, for example) where the software P1 can be recovered may be adopted as the update condition. The update condition can be applied to the update of the software of the engine ECU, for example. The position information of the recovery place may be stored in the software update device 1 in advance, or also may be transmitted from the external device 2, for example.

According to the above configuration, even when the defect using the update software UP1 occurs, the user can immediately move to the recovery place to transmit notification that the defect occurs in updating the software P1 to the worker.

<Example of Update Condition 3>

For example, the engine stopping in a predetermined period of time may be adopted as the update condition. The update condition can be applied to the update of the software of the engine ECU, for example. There is a case where the period of time during which the vehicle is not moved is almost determined in a behavior of the user. For example, the user sleeps in the period of time between 2 to 4 o'clock in the night, thereby hardly moving the vehicle in some cases. Thus, the software P1 may be updated when the engine stops in the period of time described above.

The period of time described above may be input by the user, for example. The user inputs the period of time using the user interface 13, for example. For example, the time can be measured by providing a time measuring circuit (for example, a timer circuit).

According to the above configuration, the software P1 can be updated in the period of time during which the engine stopping can be easily maintained. Thus, the necessity of interrupting the update of the software P1 or the necessity of disabling the operation of the vehicle performed by the user can be reduced.

<Example of Update Condition 4>

It is also applicable to record a past travel log and determine the period of time during which the engine stopping tends to be maintained based on the travel log. The travel log includes a route along which the user has moved and a time when the user has passed the route.

<Example of Update Condition 5>

The security ECU for controlling the security device can be adopted as the electronic device 3. The security device is a device for protecting the vehicle from a malicious third party when a driver is not in the vehicle, for example. The alarm device or the locking device for locking the steering, for example, can be adopted as the security device as described above.

The security device operates when the engine is stopping, for example. In the above case, the operation of the engine may be adopted as the update condition.

In the example described above, the download unit 15 receives the update software UP1 when receiving the update notification from the external device 2. However, the update software UP1 may be received at a subsequent timing. The reason is that the update software UP1 only needs to be received at the time of updating the software P1. Thus, it is also applicable that when the update propriety determination unit 111 determines that the update condition is established, the download unit 15 receives the update software UP1 corresponding to the update condition from the external device 2, and the transmitter 112 transmits the update software UP1 to the corresponding electronic device 3, and thereby the software update device 1 transmits the command to update the software P1.

According to the above configuration, when the software update device 1 cannot communicate with the external device 2, the software update device 1 cannot transmit the update software UP1 to the electronic device 3, thus cannot transmit the command to update the software P1. In other words, the software update device 1 can transmit the command to update the software P1 in the state where the software update device 1 can communicate with the external device 2. Thus, the software update device 1 can transmit the error notification to the external device 2 when the defect occurs in updating the software P1, for example.

In the example described above, the download unit 15 determines the propriety of the update software UP1 based on the update list. However, the external device 2 may determine the propriety of the update software UP1. For example, the external device 2 stores information for determining the propriety (for example, the version of the software P1 of the electronic device 3 and determination information being input to the update propriety determination unit 111). Then, the external device 2 may determine the propriety of the update software UP1 in a manner similar to the above description based on the information, and transmit a command to receive the update software UP1 to the software update device 1 when the external device 2 determines that the update software UP1 is necessary. In response to the command, the download unit 15 receives the update software UP1 to be received from the external device 2

In the example described above, the software update device 1 is mounted on the vehicle. However, the software update device 1 may also be mounted on a mobile phone (including a smartphone), for example. In the above case, various electronic devices which wirelessly communicate with the mobile phone, for example, may be adopted as the electronic device 3. For example, the various electronic devices include a wearable device (for example, earphones, headphones, a watch-type or glass-type device) which wirelessly communicates with the mobile phone.

When an attachment or detachment of a wearable terminal can detected, a state where the user does not wear the wearable terminal may be adopted as the update condition. That is to say, the software of the wearable terminal may be updated when the user does not wear the wearable terminal. According to the above configuration, the software can be executed when it is assumed that the wearable terminal is not used.

As described above, the software update device 1 has been shown and described in detail, the foregoing description is in all aspects illustrative, and the present software update device 1 is not limited thereto. It is therefore understood that numerous modifications and variations can be devised without departing from the scope of the disclosure.

Embodiments can be implemented in combination as long as they are not mutually inconsistent. For example, both the first operation described using FIGS. 6 and 7 and the second operation described using FIG. 8 may be adopted, or both the first operation and the third operation described using FIG. 9 may also be adopted. The operation described using FIG. 10 can be applied to any of the first operation to the third operation.

### EXPLANATION OF REFERENCE SIGNS

1 Software update device
2 External device
3 Electronic device
11 Update controller
111 Update propriety determination unit

1. A software update device which is connected to an electronic device for executing software, comprising:
a communicator configured to communicate with an external device; and
at least one processor configured to:
receive update software for updating software of the electronic device and update condition information indicating an update condition for executing an update of the software from the external device via the communicator;
determine whether or not the update condition is satisfied; and
transmit a command to update the software using the update software to the electronic device when the at least one processor determines that the update condition is satisfied.

2. The software update device according to claim 1, wherein
the electronic device transmits an error notification to the software update device when a defect occurs in updating the software,
the communicator wirelessly communicates with the external device,
the at least one processor also determines whether or not the communicator can wirelessly communicate with the external device,
transmits a command to perform the update to the electronic device when the update condition is satisfied, determines that the communicator can wirelessly communicate with the external device, and
transmits the error notification to the external device via the communicator upon receiving the error notification from the electronic device.

3. The software update device according to claim 2, wherein
the electronic device is provided in a vehicle, and
the electronic device is a device relating to a traveling of the vehicle.

4. The software update device according to claim 1, further comprising
a user interface, wherein
the at least one processor makes an inquiry as to a propriety of executing an update to a user via the user interface when determining that the update condition is satisfied.

5. The software update device according to claim 4, wherein
the at least one processor receives importance degree information indicating an importance degree of the update software via the communicator, and determines that the update can be executed without making the inquiry to the user when the importance degree is higher than a reference value.

6. The software update device according to claim 1, wherein
an update condition for executing an update of the software is set in the electronic device, and
the at least one processor adapts the update condition being set in a side of the electronic device when the update condition information is not provided from the external device.

7. The software update device according to claim 1, wherein
the communicator receives the update condition information prior to the update software, and
when the at least one processor determines that the update condition is satisfied, the at least one processor receives the update software from the external device, and transmits a command to update the software using the update software to the electronic device.

8. A software update system, comprising:
an electronic device configured to execute software;
an external device configured to store update software for updating software of the electronic device and update condition information indicating an update condition for executing an update of the software; and
a software update device being connected to the electronic device and configured to communicate with the external device, wherein
the software update device comprises:
a communicator configured to communicate with the external device; and
at least one processor configured to:
receive the update software and the update condition information from the external device via the communicator;
determine whether or not the update condition is satisfied; and
transmit a command to update the software using the update software to the electronic device when the at least one processor determines that the update condition is satisfied.

9. A method of updating software for transmitting a command to update the software to an electronic device for executing the software, comprising:
receiving update software for updating the software and update condition information indicating an update condition for executing an update of the software from an external device;
determining whether or not the update condition is satisfied; and
transmitting a command to update the software using the update software to the electronic device when it is determined that the update condition is satisfied.
